(19) United States
(12) Patent Application Publication
(10) Pub. No.: US 2026/0120614 A1
(43) Pub. Date: Apr. 30, 2026

(54) DISPLAY DEVICE AND ELECTRONIC DEVICE INCLUDING THE SAME

(71) Applicant: Samsung Display Co., Ltd., Yongin-si, Gyeonggi-do (KR)

(72) Inventor: Se Hyuk PARK, Yongin-si (KR)

(21) Appl. No.: 19/334,271

(22) Filed: Sep. 19, 2025

(30) Foreign Application Priority Data
Oct. 30, 2024 (KR) 10-2024-0151086

(51) Int. Cl. G09G 3/20

(52) U.S. Cl. CPC G09G 3/2092; G09G 2310/0267; G09G 2310/0275; G09G 2310/0297; G09G 2310/08; G09G 2330/021

(57) ABSTRACT

A display device includes: a display panel including sub-pixels; a scan driver connected to the sub-pixels by scan lines; a data driver connected to the sub-pixels by data lines; and a timing controller configured to control the scan driver and the data driver, wherein the timing controller is configured to transmit a pre-stored register value to a processor, to receive image data arranged in a sequence corresponding to the register value from the processor, and to control the data driver based on the image data.

### CROSS-REFERENCE TO RELATED APPLICATION

The present application claims priority to and the benefit of Korean Patent Application No. 10-2024-0151086, filed on Oct. 30, 2024, in the Korean Intellectual Property Office, the entire disclosure of which is incorporated herein by reference.

### BACKGROUND

### 1. Field

Aspects of some embodiments of the present disclosure relate to a display device and an electronic device including the display device.

### 2. Description of the Related Art

With the development of information technology, the importance of display devices, which serve as a connection medium between users and information, has been emphasized. Owing to the importance of the display devices, the use of various display devices, such as liquid crystal display devices, organic light-emitting display devices, and plasma display devices, has increased.

Display devices may include a display panel including pixels, and a driver configured to drive the display panel. The driver may include a scan driver configured to sequentially provide scan signals to scan lines, and a data driver configured to provide data signals to data lines. Each of the pixels may emit light with luminance corresponding to a data signal provided through the corresponding data line, in response to a scan signal provided through the corresponding scan line.

Recently, with increasing resolution, the data driver may include demultiplexers added to the output lines to output data signals in a time-division manner to a number of data lines greater than the number of output lines. As a result, the number of switching operations required to output data signals increases, thereby causing a problem of an increase in power consumption.

The above information disclosed in this Background section is only for enhancement of understanding of the background and therefore the information discussed in this Background section does not necessarily constitute prior art.

### SUMMARY

Aspects of some embodiments of the present disclosure include a display device having relatively improved efficiency, and an electronic device including the display device. For example, the display device may receive, from a processor, image data arranged in a sequence corresponding to a display panel and drive the display panel, which may make it possible to relatively reduce power consumption of the data driver and the size of a memory.

Aspects of some embodiments of the present disclosure include a display device, including a display panel including sub-pixels, a scan driver connected to the sub-pixels by scan lines, a data driver connected to the sub-pixels by data lines, and a timing controller configured to control the scan driver and the data driver. According to some embodiments, the timing controller may transmit a pre-stored register value to a processor, receive image data arranged in a sequence corresponding to the register value from the processor, and control the data driver based on the image data.

According to some embodiments, the register value may indicate one of a first logic level or a second logic level.

According to some embodiments, the sub-pixels may form pixel rows. According to some embodiments, at least one of the pixel rows may include first sub-pixels and second sub-pixels. According to some embodiments, the first sub-pixels may be connected to a first scan line of the scan lines, the second sub-pixels may be connected to a second scan line of the scan lines, and the register value may include the first logic level.

According to some embodiments, the sub-pixels may form pixel rows. According to some embodiments, the pixel rows may be connected to the respective scan lines, and the register value may have the second logic level.

According to some embodiments, the sub-pixels may form first pixel columns, and second pixel columns alternately arranged with the first pixel columns. According to some embodiments, the first pixel columns and the second pixel columns may be connected to the data driver by the data lines. According to some embodiments, based on the register value having the first logic level, a first image data set corresponding to the first pixel columns may be received from the processor during a first period, a second image data set corresponding to the second pixel columns may be received from the processor during a second period after the first period. According to some embodiments, the first and the second image data sets may be included in the image data.

According to some embodiments, the first and the second image data sets may be sequentially received during a single frame period.

According to some embodiments, each of the sub-pixels may be configured to emit light in any one of a first color, a second color, or a third color. According to some embodiments, in each of the first pixel columns, the sub-pixels that emit light of the first color and the sub-pixels that emit light of the second color may be alternately arranged. According to some embodiments, in each of the second pixel columns, the sub-pixels that emit light of the third color may be arranged.

According to some embodiments, the first image data set may include first sub-pixel data corresponding both to the sub-pixels that emit light of the first color and to the sub-pixels that emit light of the second color, and the second image data set may include second sub-pixel data corresponding to the sub-pixels that emit light of the third color.

According to some embodiments, the data driver may output data voltages corresponding to the image data to the data lines. According to some embodiments, the first pixel columns may be respectively connected to first sub-data lines. According to some embodiments, the second pixel columns may be respectively connected to second sub-data lines. According to some embodiments, the display device may further include a demultiplexer configured to selectively transmit the data voltages output through the data lines to the first sub-data lines and the second sub-data lines.

According to some embodiments, the demultiplexer may transmit data voltages corresponding to the first image data set to the first sub-data lines, and transmit data voltages corresponding to the second image data set to the second sub-data lines.

According to some embodiments, the sub-pixels may form pixel rows. According to some embodiments, the pixel rows may be connected to the scan driver by the scan lines. According to some embodiments, based on the register value being at the second logic level, an image data set corresponding to the pixel rows may be received from the processor, the image data set being included in the image data. According to some embodiments, the image data set may include sub-pixel data sequentially corresponding to the sub-pixels arranged in each of the pixel rows.

According to some embodiments, the image data set may be received during a single frame period.

According to some embodiments, the timing controller may further include a register configured to store the register value. According to some embodiments, the register value may be pre-stored based on a driving mode of the display panel.

According to some embodiments of the present disclosure may include an electronic device, including a display device including sub-pixels, and a processor configured to control the display device. According to some embodiments, the display device may transmit a pre-stored register value to the processor, receive image data arranged in a sequence corresponding to the register value from the processor, and drive the sub-pixels based on the image data.

According to some embodiments, the register value may include one of a first logic level or a second logic level.

According to some embodiments, the display device may further include a scan driver connected to the sub-pixels by scan lines. According to some embodiments, the sub-pixels may form pixel rows. According to some embodiments, at least one of the pixel rows may include first sub-pixels and second sub-pixels.

According to some embodiments, the first sub-pixels may be connected to a first scan line of the scan lines, the second sub-pixels may be connected to a second scan line of the scan lines, and the register value may have the first logic level.

According to some embodiments, the display device may further include a scan driver connected to the sub-pixels by scan lines. According to some embodiments, the sub-pixels may form pixel rows. According to some embodiments, the pixel rows may be connected to the respective scan lines, and the register value may have the second logic level.

According to some embodiments, the display device further comprises a data driver connected to the sub-pixels by data lines. According to some embodiments, the sub-pixels may form first pixel columns, and second pixel columns alternately arranged with the first pixel columns. According to some embodiments, the first pixel columns and the second pixel columns may be connected to the data driver by the data lines. According to some embodiments, based on the register value having the first logic level, a first image data set corresponding to the first pixel columns may be received from the processor during a first period, a second image data set corresponding to the second pixel columns may be received from the processor during a second period after the first period, and the first and the second image data sets may be included in the image data.

According to some embodiments, the first and the second image data sets may be sequentially received during a single frame period.

### BRIEF DESCRIPTION OF THE DRAWINGS

FIG. 1 is a block diagram illustrating an example of a display device and a processor included in an electronic device according to some embodiments of the present disclosure.

FIG. 2 is a block diagram illustrating further details of the display device of FIG. 1.

FIG. 3 is a schematic diagram illustrating aspects of any one of sub-pixels of FIG. 2.

FIG. 4 is a block diagram illustrating aspects of the portion A of FIG. 2.

FIG. 5 is a block diagram illustrating a data transmission unit (or data transmitter) and a data receiving unit (or data receiver) of FIG. 4 according to some embodiments of the present disclosure.

FIG. 6 is a flowchart illustrating aspects of a transceiving operation between the display device and the processor of FIG. 1.

FIG. 7 is a plan view illustrating aspects of the display device to which the transceiving operation of FIG. 6 is applied.

FIG. 8 is a timing diagram illustrating aspects of image data received from the processor of FIG. 6.

FIG. 9 illustrates aspects of a timing diagram in which the display device of FIG. 7 operates based on the image data of FIG. 8.

FIG. 10 is a flowchart illustrating aspects of the transceiving operation between the display device and the processor of FIG. 1.

FIG. 11 is a plan view illustrating aspects of the display device to which the transceiving operation of FIG. 10 is applied.

FIG. 12 is a timing diagram illustrating aspects of image data received from the processor of FIG. 10.

FIG. 13 illustrates aspects of a timing diagram in which the display device of FIG. 11 operates based on the image data of FIG. 12.

FIG. 14 is a schematic block diagram illustrating an example of an electronic device including the display device according to some embodiments of the present disclosure.

### DETAILED DESCRIPTION

Hereinafter, aspects of some embodiments of the disclosure will be described in more detail with reference to the attached drawings. In the following description, only parts required for understanding of operations according to some embodiments of the present disclosure will be described, and explanation of the other parts will be omitted not to make the gist of the disclosure unclear. Accordingly, the disclosure is not limited to the embodiments set forth herein but may be embodied in other types. Rather, these embodiments are provided so that the disclosure will be thorough and complete, and will fully convey the technical spirit of the disclosure to those skilled in the art.

It will be understood that in case that an element is referred to as being “coupled” or “connected” to another element, it can be directly coupled or connected to the other element or indirectly coupled or connected to the other element with intervening elements therebetween. The terminology used herein is for the purpose of describing particular embodiments only and is not intended to be limiting. In the specification, when an element is referred to as “comprising” or “including” a component, it does not preclude another component but may further include other components unless the context clearly indicates otherwise. “at least one of X, Y, or Z” and “at least one selected from the group consisting of X, Y, and Z” may be construed as X only, Y only, Z only, or any combination of two or more selected from a group of X, Y, and Z (for instance, XYZ, XYY, YZ, and ZZ). As used herein, the term “and/or” can include any and all combinations of one or more of the associated listed items.

Although the terms “first,” “second,” or the like may be used herein to describe various types of elements, these elements should not be limited by these terms. These terms are used to distinguish one element from another element. Thus, a first element discussed below could be termed a second element without departing from the teachings of the disclosure.

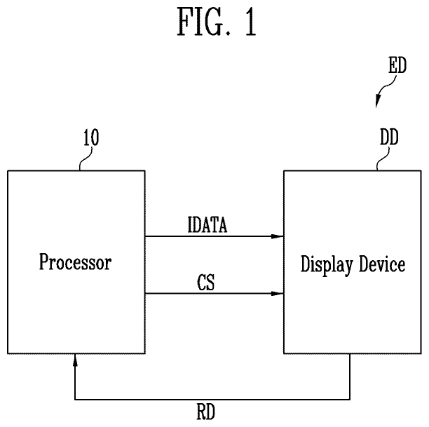

FIG. 1 is a block diagram illustrating an example of a display device DD and a processor 10 included in an electronic device ED according to some embodiments of the present disclosure.

Referring to FIG. 1, the electronic device ED may include the processor 10 and the display device DD.

The electronic device ED may include a computer, a laptop, a cellular phone, a smart phone, a personal digital assistants (PDA), a potable multimedia player (PMP), a digital TV, a digital camera, a potable game console, a navigation device, a wearable device, an internet of tings (IoT) device, an internet of everything (IoE) device, an e-book, a virtual reality (VR) device, an augmented reality (AR) device, a navigation device for vehicles, a videophone, a monitoring system, an automatic focus system, a tracking system, a motion sensor system, or the like.

The processor 10 may execute software to control the display device DD connected to the processor 10, and may perform various data processing or computing operations. For example, the processor 10 may output image data IDATA in response to an external input (or a user input, or a user command). The image data IDATA may be converted to match sub-pixel arrangement and a driving mode of the display panel, and then output. The processor 10 may be implemented as at least one of an application processor (AP), a graphics processing unit (GPU), or a central processing unit (CPU).

According to some embodiments, the processor 10 may receive a register value RD from the display device DD. The processor 10 may transmit image data IDATA and a control signal CS to the display device DD. For example, the processor 10 may generate image data IDATA arranged in a sequence corresponding to the register value RD, and may transmit the image data IDATA to the display device DD. Furthermore, the processor 10 may transmit the control signal CS including a vertical synchronization signal, a horizontal synchronization signal, a clock signal, and the like. The vertical synchronization signal may indicate a start of frame data (i.e., data corresponding to a frame period in which a single frame of image is displayed). The horizontal synchronization signal may indicate a start of a data row (i.e., one data row among a plurality of data rows included in the frame data).

The display device DD may transmit the register value RD stored in advance to the processor 10. For example, the display device DD may transmit, to the processor 10, the register value RD stored in advance at either a first logic level or a second logic level depending on the driving mode of the display panel.

The display device DD may receive image data IDATA and the corresponding control signal CS from the processor 10. The image data IDATA received from the processor 10 may be data arranged in a sequence corresponding to the register value RD. The display device DD may be controlled to display an image (e.g., a frame image) corresponding to the received image data IDATA without rearranging (or remapping) the image data IDATA. For example, the display device DD may transmit a data voltage corresponding to the receive image data IDATA to the sub-pixels without rearranging the image data IDATA to match the sub-pixel arrangement and the driving mode of the display panel. Consequently, the display device DD may be implemented without including a separate controller for performing various data processing or computing operations to rearrange the image data IDATA. Furthermore, the display device DD may be controlled to display images without storing the image data IDATA. Accordingly, the display device DD may be implemented with a size-reduced memory configured to store the image data IDATA, preset commands, or processing results. As a result, the size and production cost of the display device DD may be reduced. Furthermore, because there is no power consumption caused by a separate controller and memory for rearranging the image data IDATA, the power consumption of the display device DD may be reduced.

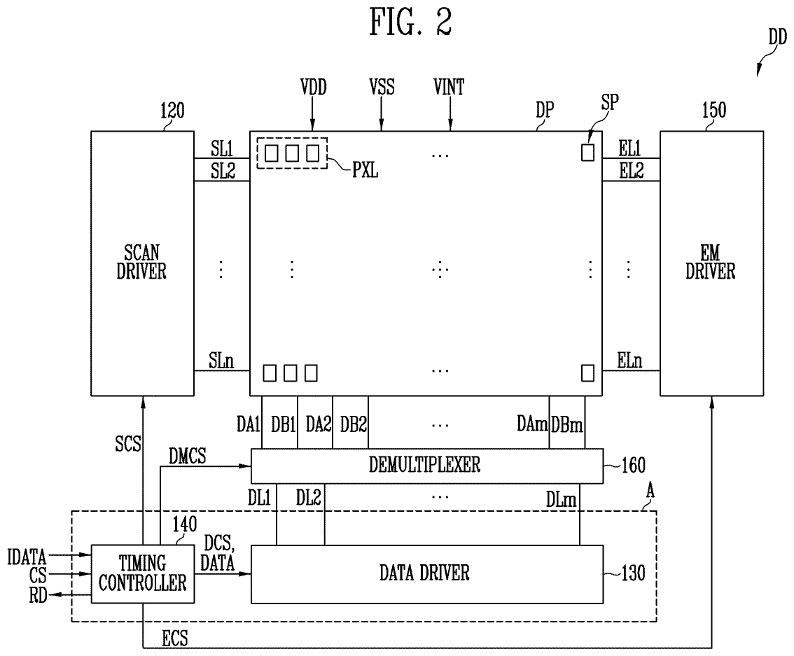

FIG. 2 is a block diagram illustrating aspects of the display device DD of FIG. 1.

Referring to FIG. 2, the display device DD may include a display panel DP, a scan driver 120 (or a gate driver), a data driver 130 (or a source driver), a timing controller 140, an emission driver 150, and a demultiplexer 160.

The display panel DP may include sub-pixels SP. The sub-pixels SP may be connected to the scan driver 120 through first to n-th scan lines SL1 to SLn (where n is an integer equal to or greater than 1). The sub-pixels SP may be connected to the data driver 130 through first to m-th data lines DL1 to DLm (where m is an integer equal to or greater than 1). The sub-pixels SP may be connected to the emission driver 150 through first to n-th emission control lines EL1 to ELn.

The sub-pixels SP may generate light in two or more colors. For example, each of the sub-pixels SP may generate light in a color, such as red, green, blue, cyan, magenta, or yellow.

Two or more sub-pixels among the sub-pixels SP may form a single pixel PXL. For example, the pixel PXL may include three sub-pixels, as illustrated in FIG. 1. As such, the pixel PXL may emit light of various colors and various luminance levels depending on the combination of light emitted from the sub-pixels included therein.

A first power voltage VDD and a second power voltage VSS may be provided to the display panel DP. The first power voltage VDD and the second power voltage VSS may be voltages required for the operation of the sub-pixels SP. The first power voltage VDD may have a voltage level higher than that of the second power voltage VSS. Furthermore, an initialization power voltage VINT may be provided to the display panel DP. The first power voltage VDD, the second power voltage VSS, and the initialization power voltage VINT may be provided by an external device of the display device DD.

The timing controller 140 may control overall operations of the display device DD. The timing controller 140 may receive image data IDATA and the corresponding control signal CS from the processor 10 (refer to FIG. 1). The timing controller 140 may provide a scan control signal SCS, a data control signal DCS, and a multiplexer control signal DMCS, in response to the control signal CS.

The timing controller 140 may correct the image data IDATA and output the corrected image data DATA. For example, the controller 110 may correct the image data IDATA based on degradation, grayscale values, color temperature, and the like of the sub-pixels SP, and output the corrected image data DATA.

The scan driver 120 may generate scan signals based on the scan control signal SCS. The scan driver 120 may sequentially provide the san signals to the san lines SL1 to SLn. The scan control signal SCS may include a start signal, clock signals, and the like, and may be provided from the timing controller 140. For example, the scan driver 120 may include a shift register (or stage) which sequentially generates and outputs pulse-type scan signals corresponding to a pulse-type start signal using clock signals.

The scan driver 120 may be placed on a side of the display panel DP. However, embodiments are not limited to the aforementioned example. For example, the scan driver 120 may be divided into two or more drivers which are physically and/or logically distinguished from each other. The drivers may be placed on a first side of the display panel DP and a second side of the display panel DP opposite to the first side. As such, the scan driver 120 may be located around the display panel DP in various forms depending on the embodiments.

The emission driver 150 may generate emission control signals based on an emission driving control signal ECS. The emission driver 150 may sequentially or simultaneously (or concurrently) provide the emission control signals to the emission control lines EL1 to ELn. The emission driving control signal ECS may include an emission start signal, emission clock signals, and the like, and may be provided from the timing controller 140. For example, the emission driver 150 may include a shift register which sequentially generates and outputs pulse-type emission control signals corresponding to a pulse-type emission start signal using emission clock signals.

The data driver 130 may generate data signals based on the corrected image data DATA and the data control signal DCS that are provided from the timing controller 140. The data driver 130 may provide the data signals to the display panel DP (or the sub-pixels SP). The data control signal DCS may be a signal for controlling the operation of the data driver 130, and include a load signal (or a data enable signal) or the like for instructing to output a valid data signal. For example, the data driver 130 may generate gamma voltages, select one of the gamma voltages that corresponds a grayscale value in the corrected image data DATA, and output a data signal (or a data voltage).

The demultiplexer 160 may be connected between the data lines DL1 to DLm and sub-data lines DA1 to DAm and DB1 to DBm. The demultiplexer 160 may provide data voltages input from the data driver 130 through the data lines DL1 to DLm based on the demultiplexer control signal DMCS, to the sub-pixels SP included in the display panel DP through the sub-data lines DA1 to DAm and DB1 to DBm.

Two or more components of the data driver 130, the timing controller 140, or the emission driver 150 may be mounted on a single integrated circuit. According to some embodiments, the data driver 130 and the timing controller 140 may be included in a single driver integrated circuit. In this case, the integrated circuit may be referred to as a timing controller embedded data driver (TED). According to some embodiments, the data driver 130 and the timing controller 140 may be respectively implemented as separate integrated circuits.

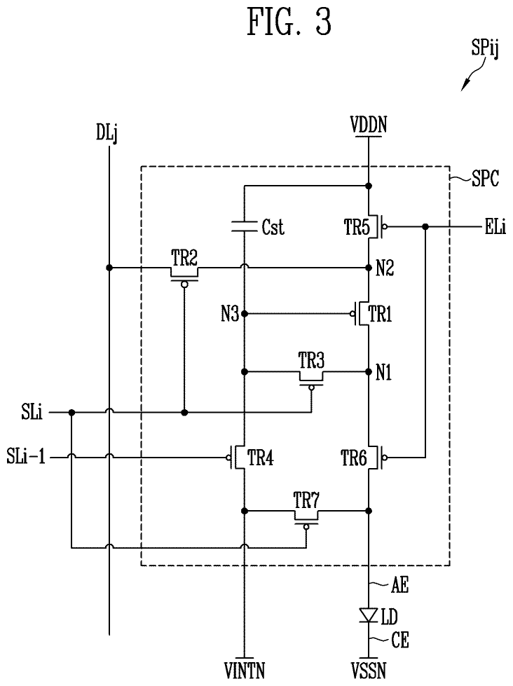

FIG. 3 is a circuit diagram illustrating aspects of any one of the sub-pixels SP of FIG. 2. Although FIG. 3 illustrates various components in a sub-pixel according to some embodiments, embodiments according to the present disclosure are not limited thereto, and according to various embodiments, the sub-pixel may include additional components or fewer components without departing from the spirit and scope of embodiments according to the present disclosure.

In FIG. 3, a sub-pixel SPij is illustrated, placed on an i-th row (where i is an integer equal to or greater than 1 and less than or equal to n) and a j-th column (where j is an integer equal to or greater than 1 and less than or equal to m) among the sub-pixels SP of FIG. 1.

Referring to FIG. 3, the sub-pixel SPij may include a sub-pixel circuit SPC and a light emitting element LD.

The sub-pixel circuit SPC may be connected to an i-th scan line SLi, an i-1-th scan line SLi-1, an i-th emission control line ELi, and a j-th data line DLj.

The sub-pixel circuit SPC may include first to seventh transistors TR1 to TR7, a storage capacitor Cst, and a light emitting element LD.

A first electrode of the first transistor TR1 may be connected to a second node N2, or may be connected to a first power node VDDN via the fifth transistor TR5. A second electrode of the first transistor TR1 may be connected to a first node N1, or may be connected to an anode electrode AE of the light emitting element LD via the sixth transistor TR6. A gate electrode of the first transistor TR1 may be connected to a third node N3. The first transistor TR1 may control, in response to the voltage of the third node N3, the amount of current flowing from the first power node VDDN to a second power node VSSN via the light emitting element LD. The first transistor TR1 may be referred to as a driving transistor.

The second transistor TR2 may be connected between the j-th data line DLj and the second node N2. A gate electrode of the second transistor TR2 may be connected to the i-th scan line SLi. When a scan signal is supplied to the i-th scan line SLi, the second transistor TR2 may be turned on to electrically connect the first electrode of the first transistor TR1 to the j-th data line DLj. The second transistor TR2 may be referred to as a switching transistor.

The third transistor TR3 may be connected between the first node N1 and the third node N3. A gate electrode of the third transistor TR3 may be connected to the i-th scan line SLi. When a scan signal is supplied to the i-th scan line SLi, the third transistor TR3 may be turned on to electrically connect the first node N1 to the third node N3.

The storage capacitor Cst may be connected between the first power node VDDN and the third node N3. The storage capacitor Cst may store a voltage corresponding both to a data signal and the threshold voltage of the first transistor TR1.

The fourth transistor TR4 may be connected between the third node N3 and the initialization power node VINTN. A gate electrode of the fourth transistor TR4 may be connected to the i-1-th scan line SLi-1, which is a preceding scan line. When a scan signal is supplied to the i-1-th scan line SLi-1, the fourth transistor TR4 may be turned on to supply an initialization power voltage VINT (refer to FIG. 1) to the first node N1. The initialization power voltage VINT may be set to have a voltage level lower than that of the data signal.

The fifth transistor TR5 may be connected between the first power node VDDN and the second node N2. A gate electrode of the fifth transistor TR5 may be connected to the i-th emission control line ELi. The fifth transistor TR5 may be turned off when an emission control signal is supplied to the i-th emission control line ELi, and may be turned on in the other cases.

The sixth transistor TR6 may be connected between the first node N1 and the light emitting element LD. A gate electrode of the sixth transistor TR6 may be connected to the i-th emission control line ELi. The sixth transistor TR6 may be turned off when an emission control signal is supplied to the i-th emission control line ELi, and may be turned on in the other cases.

The seventh transistor TR7 may be connected between the initialization power node VINTN and the anode electrode AE of the light emitting element LD. A gate electrode of the seventh transistor TR7 may be connected to the i-th scan line SLi. When a san signal supplied to the i-th scan line SLi, the seventh transistor TR7 may be turned on to supply the initialization power voltage VINT to the anode electrode AE of the light emitting element LD.

A such, the sub-pixel circuit SPC may include the first to seventh transistors TR1 to TR7, and the storage capacitor Cst. However, embodiments are not limited to the foregoing. The pixel circuit PXC may be implemented in any one of various types of circuits, each including a plurality of transistors and one or more capacitors. For example, the sub-pixel circuit SPC may include two transistors and two capacitors. Depending on embodiments of the sub-pixel circuit SPC, the number of sub-data lines included in the j-th data line DLj and the number of sub-emission control lines included in the i-th emission control line ELi may vary.

The first to seventh transistors TR1 to TR7 may be P-type transistors. Each of the first to seventh transistors TR1 to TR7 may be a metal oxide silicon field effect transistor (MOSFET). However, embodiments according to the present disclosure are not limited to the foregoing. For example, at least one of the first to seventh transistors TR1 to TR7 may be replaced with an N-type transistor.

According to some embodiments, the first to seventh transistors TR1 to TR7 may include an amorphous silicon semiconductor, a monocrystalline silicon semiconductor, a polycrystalline silicon semiconductor, an oxide semiconductor, or the like.

The light emitting element LD may include the anode electrode AE, a cathode electrode CE, and an emission layer. The emission layer may be placed between the anode electrode AE and the cathode electrode CE. When emission control signals of the i-th emission control line ELi are enabled to a low level after a data signal transmitted through the j-th data line DLj is reflected in the voltage of the second node N2, the fifth and sixth transistors TR5 and TR6 may be turned on. Furthermore, the first transistor TR1 may be turned on depending on the voltage of the third node N3, so that current can flow from the first power voltage node VDDN to the second power voltage node VSSN. The light emitting element LD may emit light corresponding to the amount of current.

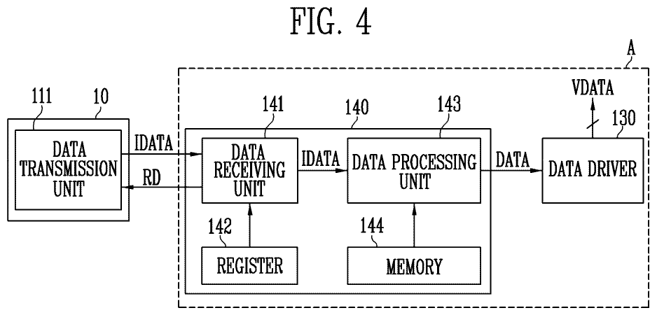

FIG. 4 is a block diagram illustrating aspects of the portion A of FIG. 2.

Referring to FIGS. 1, 2, and 4, the processor 10 may include a data transmitting unit (or data transmitter) 111. The timing controller 140 of the display device DD may include a data receiving unit (or data receiver) 141, a register 142, a data processing unit 143, and a memory 144.

The data transmitting unit 111 may transmit image data IDATA through a channel connected between the processor 10 and the display device DD. The data transmitting unit 111 may transmit the image data IDATA, arranged in a specific sequence by the processor 10, to the display device DD. For example, the data transmitting unit 111 may transmit the image data IDATA, arranged based on the sub-pixel arrangement and the driving mode of the of the display panel DP (refer to FIG. 2), to the display device DD as frame data.

The data receiving unit 141 may be connected to the channel to receive the image data IDATA provided from the processor 10. The data receiving unit 141 may transmit the register value RD to the processor 10 in advance to determine the arrangement sequence of the image data IDATA before receiving the image data IDATA. The data receiving unit 141 may receive, from the processor 10, the image data IDATA arranged in a sequence corresponding to the register value RD.

The data transmitting unit 111 and the data receiving unit 141 may correspond to a physical layer of a mobile industry processor interface (MIPI) protocol. However, the embodiments are not limited to the aforementioned example. For example, the data transmitting unit 111 and the data receiving unit 141 may correspond to a physical layer and a data link layer of an open system interconnection (OSI) 7-layer model or a network interface of a transmission control protocol/internet protocol (TCP/IP).

The register 142 may store the register value RD transmitted to the processor 10. For example, in the case where the processor 10 requests the register value RD to transmit the image data IDATA, the register value RD stored in the register 142 may be transmitted to the processor 10. The register value RD may be preset to either a first logic level or a second logic level corresponding to the sub-pixel arrangement and the driving mode of the display panel DP. For example, the register value RD may be preset to either “0”or “1”, but embodiments are not limited thereto.

The data processing unit 143 may correct the image data IDATA received through the data receiving unit 141, thus generating corrected image data DATA. The data processing unit 143 may output the generated corrected image data DATA to the data driver 130. The data processing unit 143 may be connected to the memory 144, and may be supplied with data stored in the memory 144. For example, the data processing unit 143 may correct the receive image data IDATA based on image data of a preceding frame stored in the memory 144, thus generating corrected image data DATA. The corrected image data DATA may be generated from the image data IDATA by various known methods.

The corrected image data DATA may be transmitted to the data driver 130 and provided to the display panel DP (or the sub-pixels SP). For example, the data driver 130 may provide data voltages VDATA corresponding to the corrected image data DATA to the data lines DL1 to DLm.

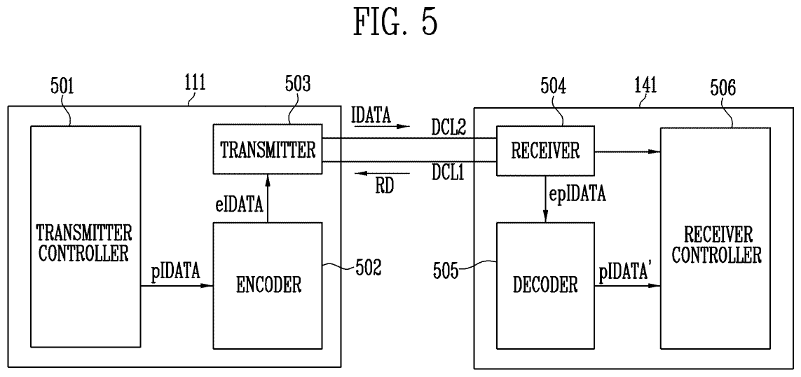

FIG. 5 is a block diagram illustrating the data transmitting unit 111 and the data receiving unit 141 of FIG. 4 according to some embodiments.

Referring to FIGS. 4 and 5, the data transmitting unit 111 of the processor 10 and the data receiving unit 141 of the timing controller 140 are illustrated.

The data transmitting unit 111 may include a transmitter controller 501, an encoder 502, and a transmitter 503. According to some embodiments, the transmitter controller 501 may provide payload image data pIDATA (or payload data) to the encoder 502. The encoder 502 may encode the payload image data pIDATA and generate encoded image data eIDATA, and may provide the encoded image data eIDATA to the transmitter 503. The transmitter 503 may add other data before and after the encoded image data eIDATA according to a preset protocol, thus generating image data IDATA. The transmitter 503 may transmit the image data IDATA.

The data receiving unit 141 may include a receiver 504, a decoder 505, and a receiver controller 506. According to some embodiments, the receiver 504 may generate a color signal using the image data IDATA, and may sample the image data IDATA (or the encoded payload image data epIDATA) based on the generated clock signal. The receiver 504 may provide the encoded payload image data epIDATA to the decoder 505. The decoder 505 may decode the encoded payload image data epIDATA, thus generating payload image data pIDATA′, and may provide the payload image data pIDATA′ to the receiver controller 506.

The data transmitting unit 111 and the data receiving unit 141 may be connected through a first line DCL1 and a second line DCL2. The transmitter 503, the first line DCL1, the second line DCL2, and the receiver 504 may form a single channel. For example, the data transmitting unit 111 may receive the register value RD through the first line DCL1, and may transmit the image data IDATA to the data receiving unit 141 through the second line DCL2.

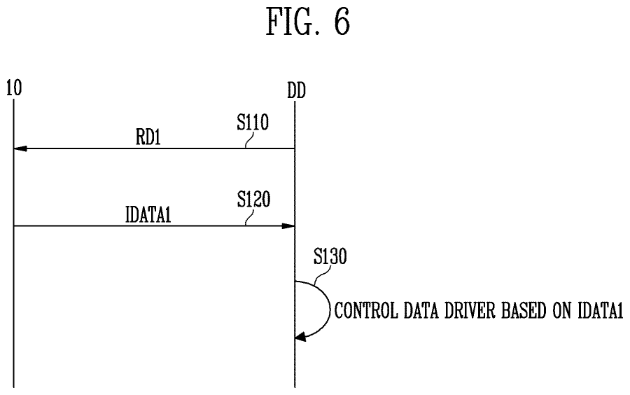

FIG. 6 is a flowchart illustrating aspects of a transceiving operation between the display device DD and the processor 10 of FIG. 1.

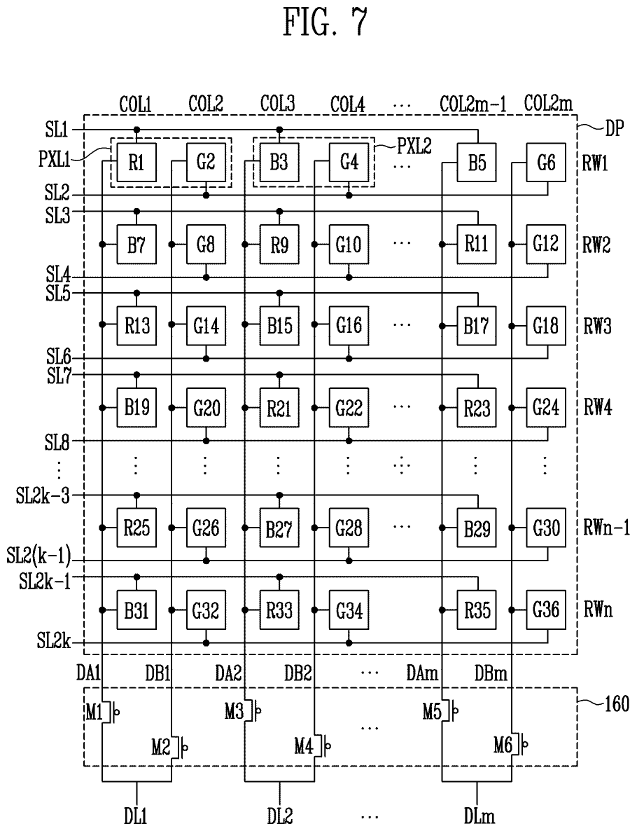

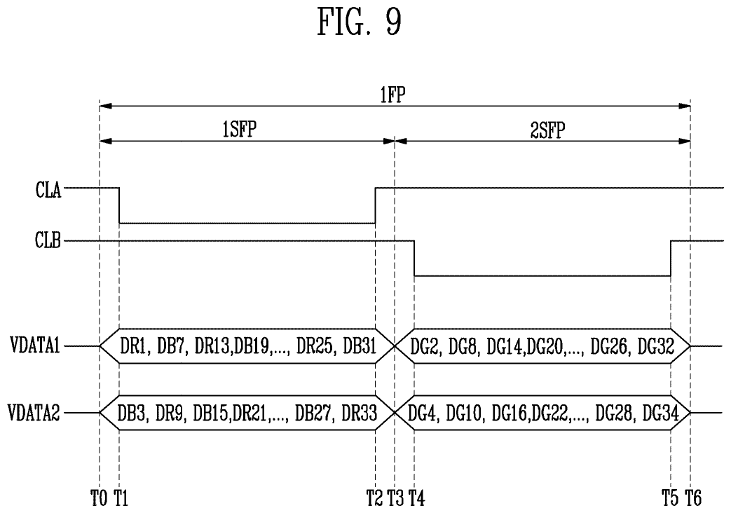

Referring to FIGS. 1 and 6, at operation S110, the display device DD may transmit a register value RD1 having a first logic level to the processor 10. According to some embodiments, in the case where the sub-pixels of the display panel DP operate in a driving mode {e.g., an alternating data driving (ADD) mode} in which the data lines are alternately driven every half cycle during a single frame period, the register value RD1 may have a first logic level. For example, the display device DD may transmit a value of “1” corresponding to the pre-stored register value RD1. In the ADD mode, the sub-pixels in the odd-numbered pixel columns may be driven during a first sub-frame period, while the sub-pixels in the even-numbered pixel columns are driven during a second sub-frame period following the first sub-frame period. The first and second sub-frame periods may be included in a single frame period. Detailed description of the structure and operation of the display panel DP driven in the ADD mode will be provided later with reference to FIGS. 7 and 9.

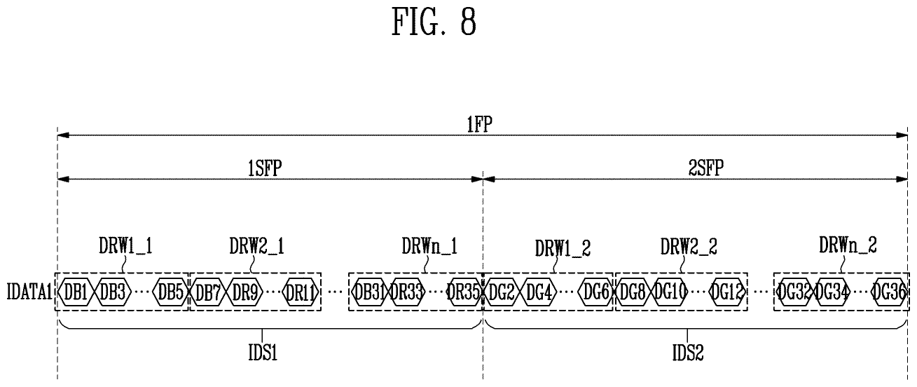

At operation S120, the processor 10 may transmit image data IDATA1 arranged in a sequence corresponding to the register value to the display device DD. According to some embodiments, upon receiving the register value RD1 having the first logic level, the processor 10 may align input image data to correspond to the ADD mode, thus generating the image data IDATA1. The processor 10 may transmit the image data IDATA1, arranged in a sequence corresponding to the ADD mode, to the display device DD as frame data. Detailed description of the arrangement of the image data IDATA1 will be provided later with reference to FIG. 8.

At operation S130, the display device DD may control the data driver 130 (refer to FIG. 2) based on the image data IDATA1. According to some embodiments, the timing controller 140 (refer to FIG. 2) may provide the image data IDATA1 to the data driver 130. The data driver 130 may convert the image data IDATA1, which is a digital data signal, to data voltages VDATA (refer to FIG. 4), which are analog data signals, in response to the data control signal DCS, and may provide the data voltages VDATA to the data lines DL1 to DLm.

FIG. 7 is a plan view illustrating aspects of the display device DD to which the transceiving operation of FIG. 6 is applied.

Referring to FIG. 7, the display panel DP having a PENTILE™ structure is illustrated. According to some embodiments, the display panel DP may have a structure in which first pixels PXL1 each including a sub-pixel configured to emit light in red (R) and a sub-pixel configured to emit light in green (G), and second pixels PXL2 each including a sub-pixel configured to emit light in blue (B) and a sub-pixel configured to emit light in green (G) are alternately arranged in an extension direction of the data lines DL1 to DLm and a direction perpendicular to the extension direction.

The display panel DP may have a structure in which the sub-pixels configured to emit red light and the sub-pixels configured to emit blue light are alternately arranged in the extension direction of the data lines DL1 to DLm, and the sub-pixels configured to emit green light are successively arranged in the extension direction of the data line DL1 to DLm.

The display panel DP may include a first pixel column COL1, a second pixel column COL2, a third pixel column COL3, a fourth pixel column COL4, . . . , a 2m-1-th pixel column COL2m-1, and a 2m-th pixel column COL2m. According to some embodiments, in the first pixel column COL1, sub-pixels configured to emit red light and sub-pixels configured to emit blue light may be alternately arranged in the extension direction of the data lines DL1 to DLm. The first pixel column COL1 may include a first sub-pixel R1, a seventh sub-pixel B7, a thirteenth sub-pixel R13, a ninth sub-pixel B19, . . . , a twenty-fifth sub-pixel R25, and a thirty-first sub-pixel B31. The sub-pixels of the first pixel column COL1 may be connected to an A1-th sub-data line DA1.

In the second pixel column COL2, sub-pixels configured to emit green light may be arranged successively in the extension direction of the data lines DL1 to DLm. The second pixel column COL2 may include a second sub-pixel G2, an eighth sub-pixel G8, a fourteenth sub-pixel G14, a twentieth sub-pixel G20, . . . , a twenty-sixth sub-pixel G26, and a thirty-second sub-pixel G32. The sub-pixels of the second pixel column COL2 may be connected to a B1-th sub-data line DB1.

In the third pixel column COL3, sub-pixels configured to emit blue light and sub-pixels configured to emit red light may be alternately arranged in the extension direction of the data lines DL1 to DLm. The third pixel column COL3 may include a third sub-pixel B3, a ninth sub-pixel R9, a fifteenth sub-pixel B15, a twenty-first sub-pixel R21, . . . , a twenty-seventh sub-pixel B27, and a thirty-third sub-pixel R33. The sub-pixels of the third pixel column COL3 may be connected to a A2-th sub-data line DA2.

In the fourth pixel column COL4, sub-pixels configured to emit green light may be arranged successively in the extension direction of the data lines DL1 to DLm. The fourth pixel column COL4 may include a fourth sub-pixel G4, a tenth sub-pixel G10, a sixteenth sub-pixel G16, a twenty-second sub-pixel G22, . . . , a twenty-eighth sub-pixel G28, and a thirty-fourth sub-pixel G34. The sub-pixels of the fourth pixel column COL4 may be connected to a B2-th sub-data line DB2.

The 2m-1-th pixel column COL2m-1 may include a fifth sub-pixel B5, an eleventh sub-pixel R11, a seventeenth sub-pixel B17, a twenty-third sub-pixel R23, . . . , a twenty-ninth sub-pixel B29, and a thirty-fifth sub-pixel R35. The sub-pixels of the 2m-1-th pixel column COL2m-1 may be connected to an Am-th sub-data line DAm. The 2m-th pixel column COL2m may include a sixth sub-pixel G6, a twelfth sub-pixel G12, an eighteenth sub-pixel G18, a twenty-fourth sub-pixel G24, . . . , a thirtieth sub-pixel G30, and a thirty-sixth sub-pixel G36. The sub-pixels of the 2m-th pixel column COL2m may be connected to a Bm-th sub-data line DBm.

In other words, in the odd-numbered pixel columns, the sub-pixels configured to emit red light and the sub-pixels configured to emit blue light may be alternately arranged. In the even-numbered pixel columns, the sub-pixels configured to emit green light may be successively arranged.

The display panel DP may include a first pixel row RW1, a second pixel row RW2, a third pixel row RW3, a fourth pixel row RW4, . . . , an n-1-th pixel row RWn-1, and an n-th pixel row RWn. According to some embodiments, in the first pixel row RW1, sub-pixels configured to emit red light and sub-pixels configured to emit blue light may be connected to the first scan line SL1. In the first pixel row RW1, sub-pixels configured to emit green light may be connected to the second scan line SL2. The first sub-pixel R1, the third sub-pixel B3, and the fifth sub-pixel B5 may be connected to the first scan line SL1. The second sub-pixel G2, the fourth sub-pixel G4, and the sixth sub-pixel G6 may be connected to the second scan line SL2.

According to some embodiments, in the second pixel row RW2, sub-pixels configured to emit red light and sub-pixels configured to emit blue light may be connected to the third scan line SL3. In the second pixel row RW2, sub-pixels configured to emit green light may be connected to the fourth scan line SL4. The seventh sub-pixel B7, the ninth sub-pixel R9, and the eleventh sub-pixel R11 may be connected to the third scan line SL3. The eighth sub-pixel G8, the tenth sub-pixel G10, and the twelfth sub-pixel G12 may be connected to the fourth scan line SL4.

In the third pixel row RW3, sub-pixels configured to emit red light and sub-pixels configured to emit blue light may be connected to the fifth scan line SL5. In the third pixel row RW3, sub-pixels configured to emit green light may be connected to the sixth scan line SL6. The thirteenth sub-pixel R13, the fifteenth sub-pixel B15, and the seventeenth sub-pixel B17 may be connected to the fifth scan line SL5. The fourteenth sub-pixel G14, the sixteenth sub-pixel G16, and the eighteenth sub-pixel G18 may be connected to the sixth scan line SL6.

In the fourth pixel row RW4, sub-pixels configured to emit red light and sub-pixels configured to emit blue light may be connected to the seventh scan line SL7. In the fourth pixel row RW4, sub-pixels configured to emit green light may be connected to the eighth scan line SL8. The nineteenth sub-pixel B19, the twenty-first sub-pixel R21, and the twenty-third sub-pixel R23 may be connected to the seventh scan line SL7. The twentieth sub-pixel G20, the twenty-second sub-pixel G22, and the twenty-fourth sub-pixel G24 may be connected to the eighth scan line SL8.

The twenty-fifth sub-pixel R25, the twenty-seventh sub-pixel B27, and the twenty-ninth sub-pixel B29 may be connected to the 2k-3-th scan line SL2k-3 (where k is an integer equal to or greater than 2 and less than or equal to n). The twenty-sixth sub-pixel G26, the twenty-eighth sub-pixel G28, and the thirtieth sub-pixel G30 may be connected to the 2(k-1)-th scan line SL2(k-1). The thirty-first sub-pixel B31, the thirty-third sub-pixel R33, and the thirty-fifth sub-pixel R35 may be connected to the 2k-1-th scan line SL2k-1. The thirty-second sub-pixel G32, the thirty-fourth sub-pixel G34, and the thirty-sixth sub-pixel G36 may be connected to the 2k-th scan line SL2k.

In other words, in each pixel column, the sub-pixels that emit red light and the sub-pixels that emit blue light may be connected to the odd-numbered scan lines, while the sub-pixels that emit green light may be connected to the even-numbered scan lines.

The demultiplexer 160 may include select transistors M1 to M6 connected between the data lines DL1 to DLm and the sub-data lines DA1 to DAm and DB1 to DBm. For example, the first select transistor M1 may be connected between the first data line DL1 and the A1-th data line DA1. The second select transistor M2 may be connected between the first data line DL1 and the B1-th data line DB1. The third select transistor M3 may be connected between the second data line DL2 and the A2-th data line DA2. The fourth select transistor M4 may be connected between the second data line DL2 and the B2-th data line DB2. The fifth select transistor M5 may be connected between the m-th data line DLm and the Am-th data line DAm. The sixth select transistor M6 may be connected between the m-th data line DLm and the Bm-th data line DBm.

The select transistors M1 to M6 may be PMOS transistors. A turn-on voltage of a PMOS transistor may be a low level voltage, and a turn-off voltage thereof may be a high level voltage. However, the embodiments are not limited to the aforementioned example. For example, at least one of the select transistors M1 to M6 may be an NMOS transistor.

FIG. 8 is a timing diagram illustrating aspects of image data received from the processor 10 of FIG. 6.

Referring to FIGS. 6, 7, and 8, image data IDATA1 transmitted to as frame data in the case where the processor 10 receives a register value RD1 having a first logic level is illustrated.

The image data IDATA1 corresponding to a single frame period 1FP may include first and second image data sets IDS1 and IDS2. The display device DD may sequentially receive the first and second image data sets IDS1 and IDS2 from the processor 10 during the single frame period 1FP. The display device DD may receive the first image data set IDS1 during a first sub-frame period 1SFP of the single frame period 1FP, and may receive the second image data set IDS2 during a second sub-frame period 2SFP of the single frame period 1FP.

According to some embodiments, during the first sub-frame period 1SFP, the display device DD may receive, from the processor 10, the first image data set IDS1 corresponding to the first pixel column COL1, the third pixel column COL3, and the 2m-1-th pixel column COL2m-1. During the second sub-frame period 2SFP after the first sub-frame period 1SFP, the display device DD may receive, from the processor 10, the second image data set IDS2 corresponding to the second pixel column COL2, the fourth pixel column COL4, and the 2m-th pixel column COL2m. In other words, the display device DD may sequentially receive, from the processor 10, the first image data set IDS1 corresponding to the odd-numbered pixel columns, and the second image data set IDS2 corresponding to the even-numbered pixel columns.

The first image data set IDS1 may include sub-pixel data corresponding to the sub-pixels that emit red light and the sub-pixels that emit blue light. For example, the first image data set IDS1 may include 1_1-th sub-pixel data DRW1_1 corresponding to the sub-pixels that emit red light and blue light in the first pixel row RW1. The 1_1-th sub-pixel data DRW1_1 may include sub-pixel data DR1, DB3, and DB5 that respectively correspond to the first sub-pixel R1, the third sub-pixel B3, and the fifth sub-pixel B5. The first image data set IDS1 may include 2_1-th sub-pixel data DRW2_1 corresponding to the sub-pixels that emit red light and blue light in the second pixel row RW2. The 2_1-th sub-pixel data DRW2_1 may include sub-pixel data DB7, DR9, and DR11 that respectively correspond to the seventh sub-pixel B7, the ninth sub-pixel R9, and the eleventh sub-pixel R11. The first image data set IDS1 may include n_1-th sub-pixel data DRWn_1 corresponding to the sub-pixels that emit red light and blue light in the n-th pixel row RWn. The n_1-th sub-pixel data DRWn_1 may include sub-pixel data DB31, DR33, and DR35 that respectively correspond to the thirty-first sub-pixel B31, the thirty-third sub-pixel R33, and the thirty-fifth sub-pixel R35.

The second image data set IDS2 may include sub-pixel data corresponding to the sub-pixels that emit green light. For example, the second image data set IDS2 may include 1_2-th sub-pixel data DRW1_2 corresponding to the sub-pixels that emit green light in the first pixel row RW1. The 1_2-th sub-pixel data DRW1_2 may include sub-pixel data DG2, DG4, and DG6 that respectively correspond to the second sub-pixel G2, the fourth sub-pixel G4, and the sixth sub-pixel G6. The second image data set IDS2 may include 2_2-th sub-pixel data DRW2_2 corresponding to the sub-pixels that emit green light in the second pixel row RW2. The 2_2-th sub-pixel data DRW2_2 may include sub-pixel data DG8, DG10, and DG12 that respectively correspond to the eighth sub-pixel G8, the tenth sub-pixel G10, and the twelfth sub-pixel G12. The second image data set IDS2 may include n_2-th sub-pixel data DRWn_2 corresponding to the sub-pixels that emit green light in the n-th pixel row RWn. The n_2-th sub-pixel data DRWn_2 may include sub-pixel data DB32, DR34, and DR36 that respectively correspond to the thirty-second sub-pixel G32, the thirty-fourth sub-pixel G34, and the thirty-sixth sub-pixel G36.

As described above, the image data IDATA1 may be data in which sub-pixel data are arranged in a sequence corresponding to the ADD mode.

FIG. 9 illustrates aspects of a timing diagram in which the display device DD of FIG. 7 operates based on the image data of FIG. 8.

Referring to FIGS. 7, 8, and 9, the single frame period 1FP may include the first sub-frame period 1SFP and the second sub-frame period 2SFP. The first sub-frame period 1SFP may be from T0 to T3, and the second sub-frame period 2SFP may be from T3 to T6. The first sub-frame period 1SFP may be a period in which data voltages for the sub-pixels that are arranged in the odd-numbered pixel columns and emit red light and blue light are output from the data driver 130. For example, during the first sub-frame period 1SFP, the data driver 130 may output data voltages corresponding to the first image data set IDS1. The second sub-frame period 2SFP may be a period in which data voltages for the sub-pixels that are arranged in the even-numbered pixel columns and emit green light are output from the data driver 130. For example, during the second sub-frame period 2SFP, the data driver 130 may output data voltages corresponding to the second image data set IDS2.

According to some embodiments, the demultiplexer control signal DMCS may include a first select signal CLA and a second select signal CLB.

During a period ranging from T1 to T2, the first select signal CLA may be enabled to a low level. The first, third, and third select transistors M1, M3, and M5 that are respectively connected to the odd-numbered pixel columns COL1, COL3, and COL2m-1 may be turned on in response to the first select signal CLA. During the period ranging from T1 to T2, first data voltages VDATA1 input through the first data line DL1 may be transmitted to the sub-pixels of the first pixel column COL1 through the A1-th sub-data line DA1. The first data voltages VDATA1 may include voltages corresponding to the sub-pixels that emit red light and the sub-pixels that emit blue light. For example, during the period ranging from T1 to T2, the first data voltages VDATA1 may include voltages corresponding to the first sub-pixel data DR1, the seventh sub-pixel data DB7, the thirteenth sub-pixel data DR13, the nineteenth sub-pixel data DB19, the twenty-fifth sub-pixel data DR25, and the thirty-first sub-pixel data DB31.

During the period ranging from T1 to T2, second data voltages VDATA2 input through the second data line DL2 may be transmitted to the sub-pixels of the third pixel column COL3 through the A2-th sub-data line DA2. The second data voltages VDATA2 may include voltages corresponding to the sub-pixels that emit blue light and the sub-pixels that emit red light. For example, during the period ranging from T1 to T2, the second data voltages VDATA2 may include voltages corresponding to the third sub-pixel data DB3, the ninth sub-pixel data DR9, the fifteenth sub-pixel data DB15, the twenty-first sub-pixel data DR21, the twenty-seventh sub-pixel data DB27, and the thirty-third sub-pixel data DR33.

During a period ranging from T4 to T5, the second select signal CLB may be enabled to a low level. The second, fourth, and sixth select transistors M2, M4, and M6 that are respectively connected to the even-numbered pixel columns COL2, COL4, and COL2m may be turned on in response to the second select signal CLB. During the period ranging from T4 to T5, first data voltages VDATA1 input through the first data line DL1 may be transmitted to the sub-pixels of the second pixel column COL2 through the B1-th sub-data line DB1. The first data voltages VDATA1 may include voltages corresponding to the sub-pixels that emit green light. For example, during the period ranging from T4 to T5, the first data voltages VDATA1 may include voltages corresponding to the second sub-pixel data DG2, the eighth sub-pixel data DG8, the fourteenth sub-pixel data DG14, the twentieth sub-pixel data DG20, the twenty-sixth sub-pixel data DG26, and the thirty-second sub-pixel data DG32.

During the period ranging from T4 to T5, second data voltages VDATA2 input through the second data line DL2 may be transmitted to the sub-pixels of the fourth pixel column COL4 through the B2-th sub-data line DB2. The second data voltages VDATA2 may include voltages corresponding to the sub-pixels that emit green light. For example, during the period ranging from T4 to T5, the second data voltages VDATA2 may include voltages corresponding to the fourth sub-pixel data DG4, the tenth sub-pixel data DG10, the sixteenth sub-pixel data DG16, the twenty-second sub-pixel data DG22, the twenty-eighth sub-pixel data DG28, and the thirty-fourth sub-pixel data DG34.

Data voltages applied to the sub-pixels through the respective data lines in response to the first and second select signals CLA and CLB may have the same configurations as the first and second data voltages; therefore, some redundant explanations may be omitted.

As such, in a single frame period 1FP, data voltages received during the first sub-frame period 1SFP may include data voltages corresponding to the red and blue sub-pixels of the odd-numbered pixel columns. Accordingly, the first, third, and fifth select transistors M1, M3, and M5 in the demultiplexer 160 may remain turned on during the first sub-frame period 1SFP. Data voltages received during the second sub-frame period 2SFP may include data voltages corresponding to the green sub-pixels in the even-numbered pixel columns. Accordingly, the second, fourth, and sixth select transistors M2, M4, and M6 in the demultiplexer 160 may remain turned on during the second sub-frame period 2SFP.

Therefore, the display device DD may reduce the number of switching operations (or turn-on operations) per unit time of the first to sixth select transistors M1 to M6 in the demultiplexer 160, thereby minimizing or reducing the power consumption.

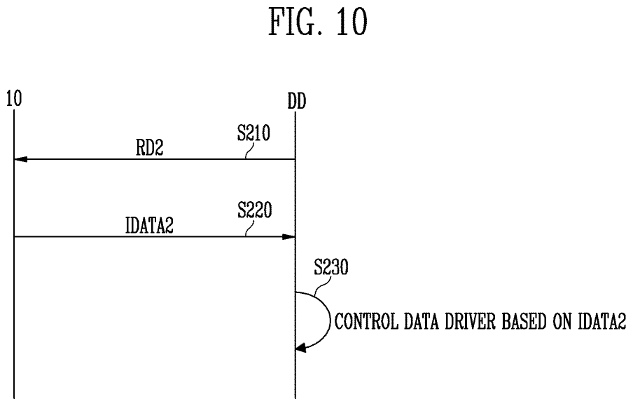

FIG. 10 is a flowchart illustrating aspects of the transceiving operation between the display device DD and the processor 10 of FIG. 1.

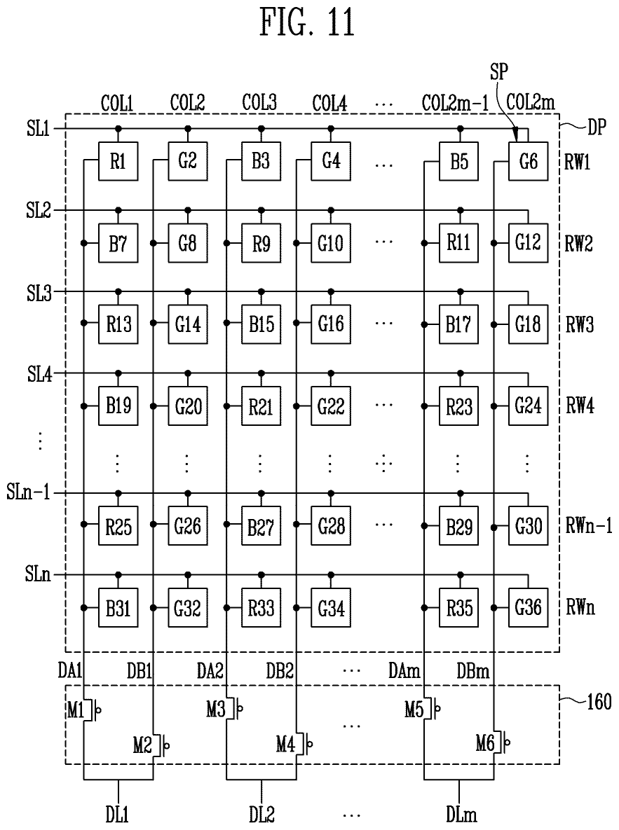

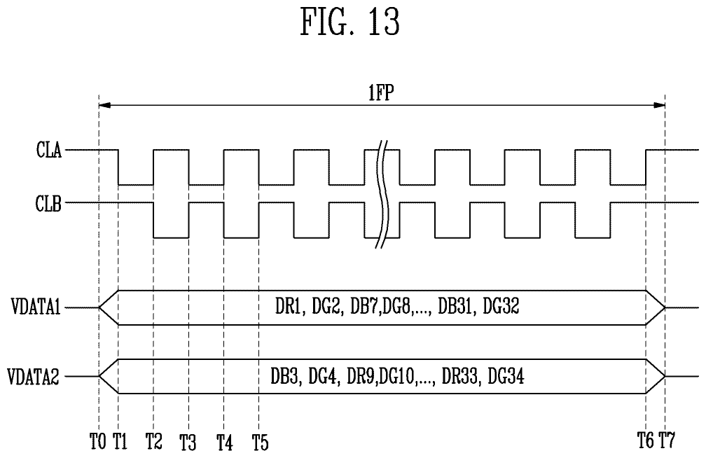

Referring to FIGS. 1 and 10, at operation S210, the display device DD may transmit a register value RD2 having a second logic level to the processor 10. According to some embodiments, in the case of a driving mode (e.g., a normal driving mode) in which the sub-pixels of the display panel DP are sequentially driven during a single frame period, the register value RD2 may have a second logic level. For example, the display device DD may transmit a value of “0” corresponding to the pre-stored register value RD2. Detailed description of the structure and operation of the display panel DP driven in the normal driving mode will be provided later with reference to FIGS. 11 and 13.

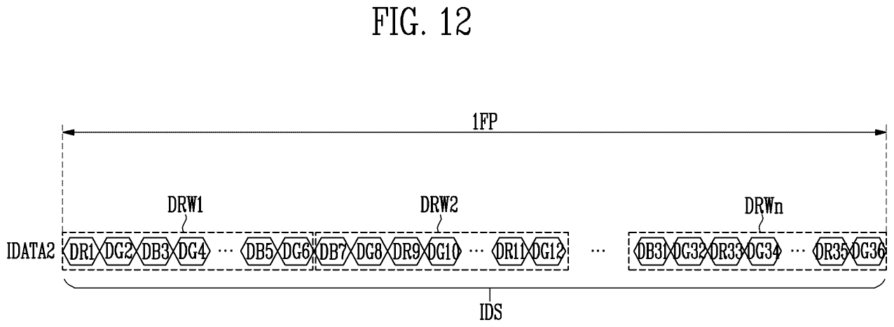

At operation S220, the processor 10 may transmit image data IDATA2 arranged in a sequence corresponding to the register value to the display device DD. According to some embodiments, upon receiving the register value RD2 having the second logic level, the processor 10 may align input image data to correspond to the normal driving mode, thus generating the image data IDATA2. The processor 10 may transmit the image data IDATA2 arranged in a sequence corresponding to the normal driving mode, to the display device DD as frame data. Detailed description of the arrangement of the image data IDATA2 will be provided later with reference to FIG. 12.

At operation S230, the display device DD may control the data driver 130 (refer to FIG. 2) based on the image data IDATA2. According to some embodiments, the timing controller 140 (refer to FIG. 2) may provide the image data IDATA2 to the data driver 130. The data driver 130 may convert the image data IDATA2, which is a digital data signal, to data voltages VDATA (refer to FIG. 4), which are analog data signals, in response to the data control signal DCS, and may provide the data voltages VDATA to the data lines DL1 to DLm.

FIG. 11 is a plan view illustrating aspects of the display device DD to which the transceiving operation of FIG. 10 is applied.

Referring to FIG. 11, the display panel DP may include a first pixel column COL1, a second pixel column COL2, a third pixel column COL3, a fourth pixel column COL4, . . . , a 2m-1-th pixel column COL2m-1, and a 2m-th pixel column COL2m.

According to some embodiments, in each of the first, third, and 2m-1-th pixel columns COL1, COL3, and COL2m-1, sub-pixels configured to emit red light and sub-pixels configured to emit blue light may be alternately arranged in the extension direction of the data lines DL1 to DLm. In each of the second, fourth, and 2m-th pixel columns COL2, COL4, and COL2m, sub-pixels configured to emit green light may be arranged successively in the extension direction of the data lines DL1 to DLm. The display panel DP may be configured in the same manner as that described with reference to FIG. 7. Therefore, some redundant explanations may be omitted.

The display panel DP may include a first pixel row RW1, a second pixel row RW2, a third pixel row RW3, a fourth pixel row RW4, . . . , an n-1-th pixel row RWn-1, and an n-th pixel row RWn. According to some embodiments, the sub-pixels in the first pixel row RW1 may be connected to the first scan line SL1. The first sub-pixel R1, the second sub-pixel G2, the third sub-pixel B3, the fourth sub-pixel G4, the fifth sub-pixel B5, and the sixth sub-pixel G6 may be connected to the first scan line SL1.

The sub-pixels in the second pixel row RW2 may be connected to the second scan line SL2. The seventh sub-pixel B7, the eighth sub-pixel G8, the ninth sub-pixel R9, the tenth sub-pixel G10, the eleventh sub-pixel R11, and the twelfth sub-pixel G12 may be connected to the second scan line SL2.

The sub-pixels in the third pixel row RW3 may be connected to the third scan line SL3. The thirteenth sub-pixel R13, the fourteenth sub-pixel G14, the fifteenth sub-pixel B15, the sixteenth sub-pixel G16, the seventeenth sub-pixel B17, and the eighteenth sub-pixel G18 may be connected to the third scan line SL3.

The sub-pixels in the fourth pixel row RW4 may be connected to the fourth scan line SL4. The ninth sub-pixel B19, the twentieth sub-pixel G20, the twenty-first sub-pixel R21, the twenty-second sub-pixel G22, the twenty-third sub-pixel R23, and the twenty-fourth sub-pixel G24 may be connected to the fourth scan line SL4.

The twenty-fifth sub-pixel R25, the twenty-sixth sub-pixel G26, the twenty-seventh sub-pixel B27, the twenty-eighth sub-pixel G28, the twenty-ninth sub-pixel B29, and the thirtieth sub-pixel G30 may be connected to the n-1-th scan line SLn-1. The thirty-first sub-pixel B31, the thirty-second sub-pixel G32, the thirty-third sub-pixel R33, the thirty-fourth sub-pixel G34, the thirty-fifth sub-pixel R35, and the thirty-sixth sub-pixel G36 may be connected to the n-th scan line SLn.

In other words, in a single pixel row, sub-pixels configured to emit red light, sub-pixels configured to emit blue light, and sub-pixels configured to emit green light may be connected to a single scan line.

The demultiplexer 160 may include select transistors M1 to M6 connected between the data lines DL1 to DLm and the sub-data lines DA1 to DAm and DB1 to DBm. The demultiplexer 160 may be configured in the same manner as that described with reference to FIG. 7. Therefore, some redundant explanations may be omitted.

FIG. 12 is a timing diagram illustrating aspects of image data received from the processor 10 of FIG. 10.

Referring to FIGS. 10, 11, and 12, there is illustrated image data IDATA2 transmitted to as frame data in the case where the processor 10 receives a register value RD2 having a second logic level.

The image data IDATA2 corresponding to a single frame period 1FP may include an image data set IDS. The display device DD may sequentially receive the image data set IDS from the processor 10 during the single frame period 1FP.

According to some embodiments, during the single frame period 1FP, the display device DD may receive, from the processor 10, the image data set IDS that sequentially correspond to the first pixel row RW1, the second pixel row RW2, the third pixel row RW3, the fourth pixel row RW4, the n-1-th pixel row RWn-1, and the n-h pixel row RWn.

The image data set IDS may include pieces of sub-pixel data which sequentially correspond to the sub-pixels arranged in each of the pixel rows. For example, the image data set IDS may include first sub-pixel data DRW1 corresponding to the sub-pixels in the first pixel row RW1. The first sub-pixel data DRW1 may include sub-pixel data DR1, DG2, DB3, DG4, DB5, and DG6 which respectively correspond to the first sub-pixel R1, the second sub-pixel G2, the third sub-pixel B3, the fourth sub-pixel G4, the fifth sub-pixel B5, and the sixth sub-pixel G6. The image data set IDS may include second sub-pixel data DRW2 corresponding to the sub-pixels in the second pixel row RW2. The second sub-pixel data DRW2 may include sub-pixel data DB7, DG8, DR9, DG10, DR11, and DG12 which respectively correspond to the seventh sub-pixel B7, the eighth sub-pixel G8, the ninth sub-pixel R9, the tenth sub-pixel G10, the eleventh sub-pixel R11, and the twelfth sub-pixel G12. The image data set IDS may include n-th sub-pixel data DRWn corresponding to the sub-pixels in the n-th pixel row RWn. The n-th sub-pixel data DRWn may include sub-pixel data DB31, DG32, DR33, DG34, DR35, DG36 which respectively correspond to the thirty-first sub-pixel B31, the thirty-second sub-pixel G32, the thirty-third sub-pixel R33, the thirty-fourth sub-pixel G34, the thirty-fifth sub-pixel R35, and the thirty-sixth sub-pixel G36.

As described above, the image data IDATA2 may be data in which sub-pixel data are arranged in a sequence corresponding to the normal driving mode.

FIG. 13 illustrates aspects of a timing diagram in which the display device DD of FIG. 11 operates based on the image data of FIG. 12.

Referring to FIGS. 11, 12, and 13, a single frame period 1FP may range from T0 to T7. The single frame period 1FP may be a period in which data voltage for the sub-pixels of the first to n-th pixel rows RW1 to RWn are output from the data driver 130. For example, during the single frame period 1FP, the data driver 130 may output data voltages corresponding to the image data set IDS.

During the single frame period 1FP, each of the first and second select signals CLA and CLB may include a plurality of pulses. For example, when the first select signal CLA is enabled to a low level (or a high level), the second select signal CLB may be enabled to a high level (or a low level).

According to some embodiments, during a period ranging from T1 to T2, the first select signal CLA may be enabled to a low level. The first, third, and fifth select transistors M1, M3, and M5 that are respectively connected to the odd-numbered pixel columns COL1, COL3, and COL2m-1 may be turned on in response to the first select signal CLA. During the period ranging from T1 to T2, first data voltages VDATA1 input through the first data line DL1 may be transmitted to the sub-pixels of the first pixel column COL1 through the A1-th sub-data line DA1. During the period ranging from T1 to T2, second data voltages VDATA2 input through the second data line DL2 may be transmitted to the sub-pixels of the third pixel column COL3 through the A2-th sub-data line DA2. Each of the first and second data voltages VDATA1 and VDATA2 may include voltages corresponding to the sub-pixels that emit blue light and the sub-pixels that emit red light.

During a period ranging from T2 to T3, the second select signal CLB may be enabled to a low level. The second, fourth, and sixth select transistors M2, M4, and M6 that are respectively connected to the even-numbered pixel columns COL2, COL4, and COL2m may be turned on in response to the second select signal CLB. During the period ranging from T2 to T3, first data voltages VDATA1 input through the first data line DL1 may be transmitted to the sub-pixels of the second pixel column COL2 through the B1-th sub-data line DB1. During the period ranging from T2 to T3, second data voltages VDATA2 input through the second data line DL2 may be transmitted to the sub-pixels of the fourth pixel column COL4 through the B2-th sub-data line DB2. Each of the first and second data voltages VDATA1 and VDATA2 may include voltages corresponding to the sub-pixels that emit green light.

During a period ranging from T3 to T4, the first select signal CLA may be enabled to a low level. During the period ranging from T3 to T4, the first data voltages VDATA1 may be transmitted to the sub-pixels of the first pixel column COL1 through the A1-th sub-data line DA1, and the second data voltages VDATA2 may be transmitted to the sub-pixels of the third pixel columns COL3 through the A2-th sub-data line DA2.

During a period ranging from T4 to T5, the second select signal CLB may be enabled to a low level. During the period ranging from T4 to T5, the first data voltages VDATA1 may be transmitted to the sub-pixels of the second pixel column COL2 through the B1-th sub-data line DB1, and the second data voltages VDATA2 may be transmitted to the sub-pixels of the fourth pixel columns COL4 through the B2-th sub-data line DB2.

As described above, data voltages received during the single frame period 1FP may include data voltages corresponding to the red sub-pixels and blue sub-pixels of the odd-numbered pixel columns, and data voltages corresponding to the green sub-pixels of the even-numbered pixel columns. For example, the first data voltages VDATA1 may include voltages corresponding to the first sub-pixel data DR1, the second sub-pixel data DG2, the seventh sub-pixel data DB7, the eighth sub-pixel data DG8, the thirty-first sub-pixel data DB31, and the thirty-second sub-pixel data DG32. The second data voltages VDATA2 may include voltages corresponding to the third sub-pixel data DB3, the fourth sub-pixel data DG4, the ninth sub-pixel data DR9, the tenth sub-pixel data DG10, the thirty-third sub-pixel data DR33, and the thirty-fourth sub-pixel data DG34.

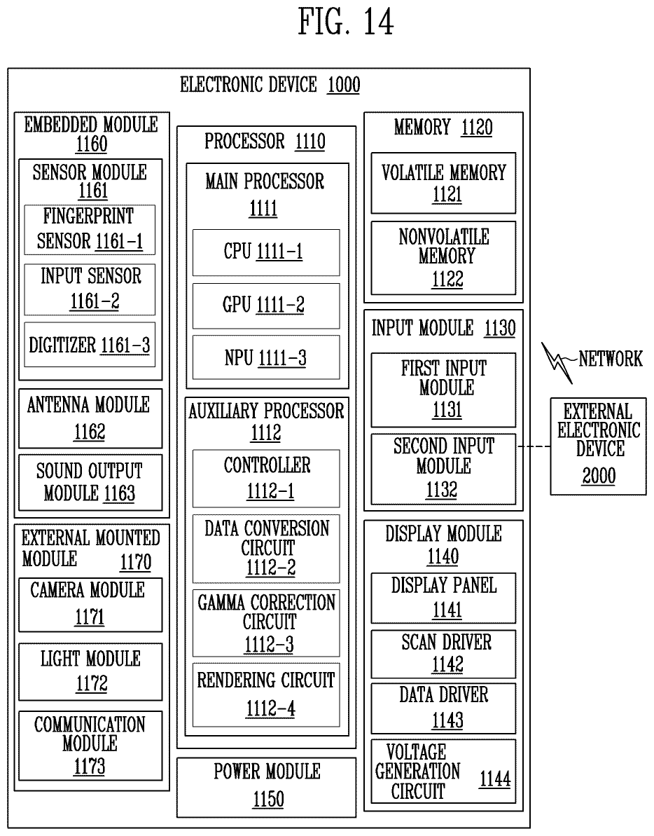

FIG. 14 is a schematic block diagram illustrating an example of an electronic device including the display device DD according to some embodiments of the present disclosure.

Referring to FIG. 14, the electronic device 1000 according to some embodiments of the present disclosure disclosure may output various types of information through a display module 1140. If a processor 1110 executes an application stored in a memory 1120, the display module 1140 may provide application information to the user through a display panel 1141.

The processor 1110 may acquire an external input through an input module 1130 or a sensor module 1161, and execute an application corresponding to the external input. For example, in the case where the user selects a camera icon (or a camera application icon) displayed on the display panel 1141, the processor 1110 may acquire a user input through an input sensor 1161-2, and activate a camera module 1171. The processor 1110 may transmit image data corresponding to an image captured by the camera module 1171 to the display module 1140. The display module 1140 may display, on the display panel 1141, an image corresponding to the captured image.

As another example, in the case where personal information authentication is executed through the display module 1140, a fingerprint sensor 1161-1 may acquire inputted fingerprint information as input data. The processor 1110 may compare input data acquired through the fingerprint sensor 1161-1 with authentication data stored in the memory 1120, and may execute an application depending on a result of the comparison. The display module 1140 may display, on the display panel 1141, information executed according to the logic of the application. The fingerprint sensor 1161-1 may be placed to make it possible to acquire fingerprint information in the overall area of the display module 1140 (or the display panel 1141).

As another example, in the case where a music streaming icon displayed on the display module 1140 is selected, the processor 1110 may acquire a user input through the input sensor 1161-2, and activate a music streaming application stored in the memory 1120. If a music playing command is inputted in the music streaming application, the processor 1110 may activate a sound output module 1163 and provide sound information corresponding to the music playing command to the user.

Hitherto, a brief description of the operation of the electronic device 1000 has been provided. Hereinafter, the configuration of the electronic device 1000 will be described in detail. Some of the components of the electronic device 1000 to be described below may be integrated into a single component, or one component may be separated into two or more components.

The electronic device 1000 may communicate with an external electronic device 2000 through a network (e.g., a short-range wireless communication network or a long-range wireless communication network). According to some embodiments, the electronic device 1000 may include a processor 1110, a memory 1120, an input module 1130, a display module 1140, a power module 1150, an embedded module 1160, and an external mounted module 1170. According to some embodiments, in the electronic device 1000, at least one of the foregoing components may be omitted, or one or more other components may be added. According to some embodiments, some components (e.g., the sensor module 1161, an antenna module 1162, or the sound output module 1163) among the foregoing components may be integrated into another component (e.g., the display module 1140).

The processor 1110 may execute software to control at least one other component (e.g., a hardware or software component) of the electronic device 1000 connected to the processor 1110 and perform various data processing or computing operations. According to some embodiments, as at least a portion of a data processing or computing operation, the processor 1110 may store a command or data received from another component (e.g., the input module 1130, the sensor module 1161, or a communication module 1173) in a volatile memory 1121, process the command or data stored in the volatile memory 1121, and store result data in a nonvolatile memory 1122. The processor 1110 may include the processor 10 of FIG. 1.

The processor 1110 may include a main processor 1111 and an auxiliary processor 1112. The main processor 1111 may include one or more of a central processing unit (CPU) 1111-1 and an application processor (AP). The main processor 1111 may further include any one of a graphic processing unit (GPU) 1111-2, a communication processor (CP), or an image signal processor (ISP). The main processor 1111 may further include a neural processing unit (NPU) 1111-3. The NPU 1111-3 may be a processor specialized to process an artificial intelligence model. The artificial intelligence model may be generated by machine learning. The artificial intelligence model may include a plurality of artificial neural network layers. An artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-networks, or a combination of two or more among the foregoing networks, but is not limited thereto. The artificial intelligence model may not only include a hardware structure but may also include an additional or substitutive software structure. At least two of the foregoing processing units and the processors may be implemented as a single integrated component (e.g., a single chip). Alternatively, the processing units and the processors may be implemented as respective independent components (e.g., a plurality of chips).

The auxiliary processor 1112 may include a controller 1112-1. The controller 1112-1 may include an interface conversion circuit and a timing control circuit. For example, the controller 1112-1 may include the timing controller 140 shown in FIG. 2. The controller 1112-1 may transmit a register value to the main processor 1111, and may receive image data form the main processor 1111. The controller 1112-1 may output various control signals needed to drive the display module 1140.

The auxiliary processor 1112 may further include a data conversion circuit 1112-2, a gamma correction circuit 1112-3, a rendering circuit 1112-4, a touch control circuit 1112-5, and the like. The data conversion circuit 1112-2 may receive image data from the controller 1112-1, compensate for the image data to display an image at a desired luminance based on characteristics of the electronic device 1000 or settings of the user, or may convert the image data to reduce power consumption or compensate for afterimages.

The gamma correction circuit 1112-3 may convert image data, a gamma reference voltage, or the like so that an image to be displayed on the electronic device 1000 can have desired gamma characteristics. The rendering circuit 1112-4 may receive image data from the controller 1112-1, and render the image data taking into account pixel arrangement or the like on the display panel 1141 applied to the electronic device 1000.

The touch control circuit may supply a touch signal to the input sensor 1161-2, and receive a sensing signal from the input sensor 1161-2 in response to the touch signal.

At least one of the data conversion circuit 1112-2, the gamma correction circuit 1112-3, the rendering circuit 1112-4, or the touch control circuit may be integrated into another component (e.g., the main processor 1111 or the controller 1112-1). At least one of the data conversion circuit 1112-2, the gamma correction circuit 1112-3, or the rendering circuit 1112-4 may be integrated into a data driver 1143 to be described below.

The memory 1120 may store a variety of data to be used in at least one component (e.g., the processor 1110 or the sensor module 1161) of the electronic device 1000, and input data or output data for a command pertaining to the variety of data. Furthermore, the memory 1120 may store a variety of setting data corresponding to settings of the user. The memory 1120 may include at least one of the volatile memory 1121 or the nonvolatile memory 1122.

The input module 1130 may receive a command or data to be used in a component (e.g., the processor 1110, the sensor module 1161, or the sound output module 1163) of the electronic device 1000 from an external device (e.g., the user or an external electronic device 2000) provided outside the electronic device 1000.

The input module 1130 may include a first input module 1131 configured to receive a command or data from the user, and a second input module 1132 configured to receive a command or data from the external electronic device 2000. The first input module 1131 may include a microphone, a mouse, a keyboard, a key (e.g., a button), or a pen (e.g., a passive pen or an active pen). The second input module 1132 may support a designated protocol that can be connected to the external electronic device 2000 in a wired or wireless manner. According to some embodiments, the second input module 1132 may include a high definition multimedia interface (HDMI), a universal serial bus (USB) interface, an SD card interface, or an audio interface. The second input module 1132 may include a connector, e.g., an HDMI connector, a USB connector, an SD card connector, or an audio connector (e.g., a headphone connector), for physical connection with the external electronic device 2000.

The display module 1140 may provide visual information to the user. The display module 1140 may include a display panel 1141, a scan driver 1142, and a data driver 1143.

The display panel 1141 (or a display) may include a liquid crystal display panel, an organic light emitting display panel, or an inorganic light emitting display panel. The type of display panel 1141 is not limited to a particular type. The display panel 1141 is a rigid type panel, or a flexible type panel, which is rollable or foldable.

The display module 1140 may further include a support, a bracket, or a heat dissipater, which supports the display panel 1141.

The display panel 1141 may receive image data from the auxiliary processor 1112, and display images while controlling the amount of current flowing from the first power voltage (or first power supply) VDD to the second power voltage (or second power supply) VSS via the pixels PXL in correspondence with the image data. The display panel 1141 may correspond to the display panel DP illustrated in FIG. 1.

The scan driver 1142 may be mounted on the display panel 1141 as a driving chip. The scan driver 1142 may be integrated on the display panel 1141. For example, the scan driver 1142 may include an amorphous silicon TFT gate (ASG) driver circuit, a low temperature polycrystalline silicon (LTPS) TFT gate driver circuit, or an oxide semiconductor TFT gate (OSG) driver circuit, which is internalized in the display panel 1141. The scan driver 1142 may receive a control signal from the controller 1112-1, and output scan signals to the display panel 1141 in response to the control signal. The scan driver 1142 may include the scan driver 120 illustrated in FIG. 2.

The display module 1140 may further include an emission driver. The emission driver may output an emission control signal to the display panel 1141 in response to a control signal received from the controller 1112-1. The emission driver may be formed separately from the scan driver 1142, or may be integrated into the scan driver 1142.

The data driver 1143 may receive a control signal from the controller 1112-1, convert image data into an analog voltage (e.g., a data signal) in response to the control signal, and output data signals to the display panel 1141. The data driver 1143 may include the data driver 130 illustrated in FIG. 2.

The data driver 1143 may be integrated into another component (e.g., the controller 1112-1). The functions of the interface conversion circuit and the timing control circuit of the controller 1112-1 may be integrated into the data driver 1143.

The display module 1140 may further include a voltage generation circuit 1144. The voltage generation circuit 1144 may output various voltages needed to drive the display panel 1141.

According to some embodiments, the data driver 1143 may convert data that is included in image data received from the processor 1110 and corresponds to red (R), green (G), and blue (B) to a red data signal (or a data voltage), a green data signal, and a blue data signal, and provide the data signals to a plurality of pixel columns included in the display panel 1141 during a single horizontal period.

The power module 1150 may supply power to the components of the electronic device 1000. The power module 1150 may include a battery to store power voltage. The battery may include a primary cell, which cannot be recharged, and a secondary cell or a fuel cell, which are rechargeable. The power module 1150 may include a power management integrated circuit (PMIC). The PMIC may supply optimized power to each of the foregoing modules and modules to be described below. The power module 1150 may include a wireless power transceiver that is electrically connected with the battery. The wireless power transceiver may include a plurality of coiled antenna radiators. The voltage generation circuit 1144 may be integrated with the power module 1150.

The electronic device 1000 may further include an embedded module 1160 and an external mounted module 1170. The embedded module 1160 may include a sensor module 1161, an antenna module 1162, and a sound output module 1163. The external mounted module 1170 may include a camera module 1171, a light module 1172, and a communication module 1173.

The sensor module 1161 may sense an input from the body of the user or an input from a pen of the first input module 1131, and generate an electric signal or a data value corresponding to the input. The sensor module 1161 may include at least one of a fingerprint sensor 1161-1, an input sensor 1161-2, or a digitizer 1161-3.

The fingerprint sensor 1161-1 may generate a data value corresponding to the fingerprint of the user. The fingerprint sensor 1161-1 may include any one of an optical fingerprint sensor or a capacitive fingerprint sensor.

The input sensor 1161-2 may generate a data value corresponding to coordinate information of the input from the body of the user or the input from the pen. The input sensor 1161-2 may generate a data value corresponding to the amount of change in capacitance by the input. The input sensor 1161-2 may sense an input from a passive pen, or transmit or receive data to or from an active pen.

The input sensor 1161-2 may measure a biometric signal pertaining to biometric information, such as a blood pressure, body fluid, or body fat. For example, in the case where the user brings a part of his/her body into contact with the sensor layer or the sensing panel and remains stationary for a certain time, the input sensor 1161-2 may sense a biometric signal, based on a change in electric field by the part of his/her body, and output information desired by the user to the display module 1140.

The digitizer 1161-3 may generate a data value corresponding to coordinate information of an input from a pen. The digitizer 1161-3 may generate data values corresponding to electromagnetic variations caused by the input. The digitizer 1161-3 may sense an input from a passive pen, or transmit or receive data to or from an active pen.

At least one of the fingerprint sensor 1161-1, the input sensor 1161-2, or the digitizer 1161-3 may be implemented as a sensor layer formed on the display panel 1141 through a successive process. At least one of the fingerprint sensor 1161-1, the input sensor 1161-2, or the digitizer 1161-3 may be placed over the display panel 1141. Any one of the fingerprint sensor 1161-1, the input sensor 1161-2, or the digitizer 1161-3, for example, the digitizer 1161-3, may be placed under the display panel 1141.

At least two of the fingerprint sensor 1161-1, the input sensor 1161-2, or the digitizer 1161-3 may be formed to be integrated into a single sensing panel through the same process. In the case where at least two of the fingerprint sensor 161-1, the input sensor 161-2, or the digitizer 161-3 are integrated into a single sensing panel, the sensing panel may be placed between the display panel 1141 and a window placed over the display panel 1141. According to some embodiments, the sensing panel may be placed on the window, and the position of the sensing panel is not particularly limited.

At least one of the fingerprint sensor 1161-1, the input sensor 1161-2, or the digitizer 1161-3 may be embedded in the display panel 1141. In other words, during a process of forming components (e.g., a light emitting element, a transistor, and the like) included in the display panel 1141, at least one of the fingerprint sensor 1161-1, the input sensor 1161-2, or the digitizer 1161-3 may be formed simultaneously (or concurrently) with the components.

In addition, the sensor module 1161 may generate an electrical signal or data value corresponding to internal conditions or external conditions of the electronic device 1000. The sensor module 1161 may further include, for example, a gesture sensor, a gyroscope sensor, an atmospheric sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The antenna module 1162 may include one or more antennas to transmit or receive a signal or power to or from an external device. According to some embodiments, the communication module 1173 may transmit a signal to an external electronic device or receive a signal from the external electronic device through an antenna suitable for a communication scheme. An antenna pattern of the antenna module 1162 may be integrated to a component of the display module 1140 (e.g., the display panel 1141 of the display module 1140) or the input sensor 1161-2.

The sound output module 1163 may be a device for outputting a sound signal to a device provided outside the electronic device 1000, and, for example, may include a speaker, which is used for typical purposes, such as reproducing multimedia or record data, and a receiver, which is used only for phone reception. According to some embodiments, the receiver may be integrally or separately formed with a speaker. A sound output pattern of the sound output module 1163 may be integrated into the display module 1140.

The camera module 1171 may capture a static image or a video. According to some embodiments, the camera module 1171 may include one or more lenses, an image sensor, or an image signal processor. The camera module 1171 may further include an infrared camera capable of sensing the presence of the user, the position of the user, a line of sight of the user, or the like.

The light module 1172 may provide light. The light module 1172 may include a light emitting diode or a xenon lamp. The light module 1172 may be operated interlocking with the camera module 1171 or operated independently therefrom.

The communication module 1173 may form a wired or wireless communication channel between the electronic device 1000 and the external electronic device 2000, and support execution of communication through the formed communication channel. The communication module 1173 may include either or both a wireless communication module, such as a cellular communication module, a short-range wireless communication module, or a global navigation satellite system (GNSS) communication module, and a wired communication module, such as a local area network (LAN) communication module, or a power line communication module. The communication module 1173 may communicate with the external electronic device 2000 through a short-range communication network, such as Bluetooth, WiFi Direct or infrared data association (IrDA), or a long-range communication network, such as a cellular network, an internet, or a computer network (e.g., LAN or WAN). The various types of communication modules 1173 described above may be implemented as a single chip or may be implemented as respective separate chips.

The input module 1130, the sensor module 1161, the camera module 1171, and the like, interlocking with the processor 1110, may be used to control the operation of the display module 1140.

The processor 1110 may output a command or data to the display module 1140, the sound output module 1163, the camera module 1171, or the light module 1172, based on input data received from the input module 1130. For example, the processor 1110 may generate image data in response to input data applied through a mouse, an active pen, or the like and output the image data to the display module 1140, or may generate command data in response to input data and output the command data to the camera module 1171 or the light module 1172. In the case where input data is not received from the input module 1130, the processor 1110 may convert the operation mode of the electronic device 1000 to a low-power mode or a sleep mode, thus reducing the power consumption of the electronic device 1000.

The processor 1110 may output a command or data to the display module 1140, the sound output module 1163, the camera module 1171, or the light module 1172, based on sensing data received from the sensor module 1161. For example, the processor 1110 may compare authentication data applied from the fingerprint sensor 1161-1 with the authentication data stored in the memory 1120, and may execute an application depending on a result of the comparison. The processor 1110 may execute a command based on sensing data sensed by the input sensor 1161-2 or the digitizer 1161-3, or output corresponding image data to the display module 1140. In the case where the sensor module 1161 includes a temperature sensor, the processor 1110 may receive temperature data for a measured temperature from the sensor module 1161, and further execute a luminance correction operation for the image data based on the temperature data.

The processor 1110 may receive measurement data for the presence of the user, the position of the user, a line of sight of the user, or the like from the camera module 1171. The processor 1110 may further execute a luminance correction operation for the image data based on the measurement data. For example, the processor 1110 that has determined whether the user is present through an input from the camera module 1171 may output, to the display module 1140, image data the luminance of which is corrected by the data conversion circuit 1112-2 or the gamma correction circuit 1112-3.

Some components among the foregoing components may be connected to each other by a communication scheme, e.g., a bus, general purpose input/output (GPIO), a serial peripheral interface (SPI), a mobile industry processor interface (MIPI), or a ultra path interconnect (UPI) link, which can be used between peripheral devices, and may thus exchange a signal (e.g., a command or data) with one another. The processor 1110 may communicate with the display module 1140 through an interface (e.g., a set or predefined interface). For example, any one of the foregoing communication schemes may be used, and the interface is not limited to the foregoing communication schemes.

In a display device and an electronic device including the display device according to some embodiments of the disclosure, the display device may receive image data arranged in a sequence corresponding to a driving mode of a display panel from a processor and control a data driver based on the received image data.

Accordingly, the display device may not include a separate controller or memory for performing various data processing or operations to rearrange the image data. As a result, because no additional space or power is required for a separate controller or memory to rearrange the image data, the size and production cost of the display device may be reduced, and the power consumption can be reduced, thereby relatively improving efficiency.

Various embodiments of the disclosure may provide a display device having relatively improved efficiency, and an electronic device including the display device.

The effects of the disclosure are not limited by the foregoing, and other various effects are anticipated herein.

The electronic or electric devices and/or any other relevant devices or components according to embodiments of the present invention described herein may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the exemplary embodiments of the present invention.

Although certain embodiments and implementations have been described herein, other embodiments and modifications will be apparent from the foregoing description. Accordingly, the characteristics of embodiments according to the present disclosure are not limited to the foregoing embodiments, but rather to the broader scope of the appended claims and their equivalents.

What is claimed is:

1. A display device, comprising:
a display panel including sub-pixels;
a scan driver connected to the sub-pixels by scan lines;
a data driver connected to the sub-pixels by data lines; and
a timing controller configured to control the scan driver and the data driver,
wherein the timing controller is configured to transmit a pre-stored register value to a processor, to receive image data arranged in a sequence corresponding to the register value from the processor, and to control the data driver based on the image data.

2. The display device according to claim 1, wherein the register value indicates one of a first logic level or a second logic level.

3. The display device according to claim 2,
wherein the sub-pixels form pixel rows,
wherein at least one of the pixel rows includes first sub-pixels and second sub-pixels, and
wherein the first sub-pixels are connected to a first scan line of the scan lines, the second sub-pixels are connected to a second scan line of the scan lines, and the register value has the first logic level.

4. The display device according to claim 2,
wherein the sub-pixels form pixel rows, and
wherein the pixel rows are connected to the respective scan lines, and the register value has the second logic level.

5. The display device according to claim 2,
wherein the sub-pixels form first pixel columns, and second pixel columns alternately arranged with the first pixel columns,
wherein the first pixel columns and the second pixel columns are connected to the data driver by the data lines, and
wherein based on the register value having the first logic level, a first image data set corresponding to the first pixel columns is configured to be received from the processor during a first period, a second image data set corresponding to the second pixel columns is configured to be received from the processor during a second period after the first period, and the first and the second image data sets are included in the image data.

6. The display device according to claim 5, wherein the first and the second image data sets are configured to be sequentially received during a single frame period.

7. The display device according to claim 5,
wherein each of the sub-pixels is configured to emit light in any one of a first color, a second color, or a third color,
wherein in each of the first pixel columns, the sub-pixels that emit light of the first color and the sub-pixels that emit light of the second color are alternately arranged, and
wherein each of the second pixel columns, the sub-pixels configured to emit light of the third color are arranged.

8. The display device according to claim 7, wherein the first image data set includes first sub-pixel data corresponding both to the sub-pixels configured to emit light of the first color and to the sub-pixels configured to emit light of the second color, and the second image data set includes second sub-pixel data corresponding to the sub-pixels configured to emit light of the third color.

9. The display device according to claim 5,
wherein the data driver is configured to output data voltages corresponding to the image data to the data lines,
wherein the first pixel columns are respectively connected to first sub-data lines, and
wherein the second pixel columns are respectively connected to second sub-data lines, and
the display device further comprising a demultiplexer configured to selectively transmit the data voltages output through the data lines to the first sub-data lines and the second sub-data lines.

10. The display device according to claim 9, wherein the demultiplexer is configured to transmit data voltages corresponding to the first image data set to the first sub-data lines, and to transmit data voltages corresponding to the second image data set to the second sub-data lines.

11. The display device according to claim 2,
wherein the sub-pixels form pixel rows,
wherein the pixel rows are connected to the scan driver by the scan lines,
wherein based on the register value being at the second logic level, an image data set corresponding to the pixel rows is configured to be received from the processor, the image data set being included in the image data, and
wherein the image data set includes sub-pixel data sequentially corresponding to the sub-pixels arranged in each of the pixel rows.

12. The display device according to claim 11, wherein the image data set is configured to be received during a single frame period.

13. The display device according to claim 1,
wherein the timing controller further comprises a register configured to store the register value, and
wherein the register value is pre-stored based on a driving mode of the display panel.

14. An electronic device, comprising:
a display device including sub-pixels; and
a processor configured to control the display device, and
wherein the display device is configured to transmit a pre-stored register value to the processor, to receive image data arranged in a sequence corresponding to the register value from the processor, and to drive the sub-pixels based on the image data.

15. The electronic device according to claim 14, wherein the register value indicates one of a first logic level or a second logic level.

16. The electronic device according to claim 15,
wherein the display device further comprises a scan driver connected to the sub-pixels by scan lines,
wherein the sub-pixels form pixel rows,
wherein at least one of the pixel rows includes first sub-pixels and second sub-pixels, and
wherein the first sub-pixels are connected to a first scan line of the scan lines, the second sub-pixels are connected to a second scan line of the scan lines, and the register value has the first logic level.

17. The electronic device according to claim 15,
wherein the display device further comprises a scan driver connected to the sub-pixels by scan lines,
wherein the sub-pixels form pixel rows, and
wherein the pixel rows are connected to the respective scan lines, and the register value has the second logic level.

18. The electronic device according to claim 14,
wherein the display device further comprises a data driver connected to the sub-pixels by data lines,
wherein the sub-pixels form first pixel columns, and second pixel columns alternately arranged with the first pixel columns,
wherein the first pixel columns and the second pixel columns are connected to the data driver by the data lines, and
wherein based on the register value has a first logic level, a first image data set corresponding to the first pixel columns is configured to be received from the processor during a first period, a second image data set corresponding to the second pixel columns is configured to be received from the processor during a second period after the first period, and the first and the second image data sets are included in the image data.

19. The electronic device according to claim 18, wherein the first and the second image data sets are configured to be sequentially received during a single frame period.
